(19) United States
(12) Patent Application Publication
(10) Pub. No.: US 2026/0228253 A1
(43) Pub. Date: Aug. 6, 2026

(54) SYSTEMS AND METHODS FOR ARTIFICIAL INTELLIGENCE CHATBOT

(71) Applicant: The Toronto-Dominion Bank, Toronto (CA)

(72) Inventors: Ronald KIELSTRA, Beamsville (CA); Anil Stewart BAKHLE, Guelph (CA); Lan Ting HUANG, Toronto (CA); Christina XIE, Oakville (CA)

(73) Assignee: The Toronto-Dominion Bank, Toronto (CA)

(21) Appl. No.: 19/046,647

(22) Filed: Feb. 6, 2025

(51) Int. Cl. G06F 16/3329; G06F 16/34; H04L 51/02

(52) U.S. Cl. CPC G06F 16/33295; G06F 16/345; H04L 51/02

(57) ABSTRACT

The present disclosure relates to systems and methods for providing context to the artificial intelligence chatbots. The system comprises a processor; a communications module coupled to the processor; and a computer-readable memory coupled to the processor. The processor executes a computer-executable method having the steps of: generating a summary of an exchange with an artificial intelligence (AI)-assistant chatbot; receiving a query via the communications module; identifying, based on the summary of the exchange, at least a portion of the summary resembling the query; and providing the portions of the summary to the AI-assistant chatbot as input, together with the query, to answer the query with a response.

### TECHNICAL FIELD

The present disclosure relates to artificial intelligence chatbots and, in particular, to systems and methods for controlling memory resources for artificial intelligence chatbots.

### BACKGROUND

Large Language Models (LLMs) have pre-trained embeddings and a context window. The pre-trained embeddings include a general meaning of words and phrases based on the amount of training data. The context window holds embeddings of tokens relevant to the current conversation to maintain the flow of a conversation. The context window typically has a fixed maximum token limit. Once the limit is reached, the context window discards earlier context leading to the potential loss of information.

The context window is limited in size due to the cost to maintain and process the conversation into embeddings. When the context window is large, memory usage increases resulting in LLM performance and efficiency degradation without significant optimization. For example, GPT-4 can handle 8,000 tokens in its context window. Claude 3.5 Sonnet by Anthropic features a context window of up to 200,000 tokens. Google Gemini 1.5 has a context window of up to 2 million tokens. Magic. dev LTM-2-Mini includes a 100 million token context window for handling massive datasets. Mistral Large 2 and Llama 3.2 both use 128,000 token context windows. Some of these LLMs incorporate techniques such as sparse attention, long-range attention, memory augmentation, memory compression, hierarchical attention, and/or distribution of workload across multiple processors.

### BRIEF DESCRIPTION OF THE DRAWINGS

Reference will now be made, by way of example, to the accompanying drawings which show example embodiments of the present application and in which:

FIG. 1 is a schematic operation diagram illustrating an operating environment;

FIG. 2 is a high-level schematic diagram of a computing device;

FIG. 3 shows a simplified organization of software components stored in memory of the computing device of FIG. 2;

FIG. 4 shows a high-level schematic diagram on an example parallel processing architecture;

FIG. 5 shows, in flowchart form, an example method for controlling memory resources for an AI-assistant chatbot;

FIG. 6 shows, in flowchart form, an example method for chunking and merging chunks from an exchange to generate the contextual summary;

FIG. 7 shows, in flowchart form, another example method for revising the contextual summary based on a current query exchange;

FIG. 8 shows, in flowchart form, an example method for providing operations to a profile server from the AI-assistant chatbot; and

FIG. 9 shows a high-level schematic diagram of a development platform for training the AI engine of the AI-assistant chatbot.

Like reference numerals are used in the drawings to denote like elements and features.

### DETAILED DESCRIPTION

According to an aspect, there is provided a computer system comprising: a processor; a communications module coupled to the processor; and a computer-readable memory coupled to the processor, the computer-readable memory storing instructions that, when executed, configure the processor to: generate a summary of an exchange with an AI-assistant chatbot; receive a query via the communications module; identify, based on the summary of the exchange, at least a portion of the summary resembling the query; and provide the portions of the summary to the AI-assistant chatbot as input, together with the query, to answer the query with a response. The instructions may further configure the processor to: revise the summary based on the response; and/or provide the response and the summary of the exchange to the AI-assistant chatbot to revise the summary.

According to an aspect, the instructions may further configure the processor to: perform chunking on the exchange to provide a plurality of chunks; merge the response with a contextually-similar chunk from the plurality of chunks to produce a merged chunk; generate an embedding of the merged chunk and store the embedding in a vector database; and/or convert the query into a query embedding; and identify at least one embedding from the vector database resembling the query embedding to identify the portion of the summary resembling the query.

According to yet another aspect, the instructions may further configure the processor to provide the summary of at least one previous exchange associated with an account to the AI-assistant chatbot prior to receiving the query.

According to yet another aspect, the instructions may further configure the processor to: provide the revised summary via the communications module to a remote device; and/or receive a confirmation message from the remote device via the communications module indicating the revised summary is accurate.

According to another aspect, there is provided a computer-implemented method comprising: generating a summary of an exchange with an AI-assistant chatbot; receiving a query via a communications module; identifying, based on the summary of the exchange, at least a portion of the summary resembling the query; and providing the portions of the summary to the AI-assistant chatbot as input, together with the query, to answer the query with a response. The method may further comprise: revising the summary based on the response to produce a revised summary; providing the response and the summary of the exchange to the AI-assistant chatbot to revise the summary; and/or providing the response and the summary of the exchange to the AI-assistant chatbot to revise the summary. The method may further comprise: providing the revised summary via the communications module to a remote device; and/or receiving a confirmation message from the remote device via the communications module indicating the revised summary is accurate.

According to another aspect, the computer-implemented method may further comprise: performing chunking on the exchange to provide a plurality of chunks; merging the response with a contextually-similar chunk from the plurality of chunks to produce a merged chunk; generating an embedding of the merged chunk and store the embedding in a vector database; and/or converting the query into a query embedding; and identifying at least one embedding from the vector database resembling the query embedding to identify the portion of the summary resembling the query.

According to yet another aspect, the method may comprise providing the summary of at least one previous exchange associated with an account to the AI-assistant chatbot prior to receiving the query.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all the elements, and may include additional elements.

In the present application, the phrase “at least one of . . . or . . . ” is intended to cover any one or more of the listed elements, including any one of the listed elements alone, any sub-combination, or all the elements, and may include additional elements, and may not require all the elements.

The example aspects are directed to a platform which hosts a software application(s) that provides a chatbot functionality. Entities can open a chat window on their client device and conduct a chat conversation with the chatbot through the software application. In one aspect, the chat window may be a chat element. The chat conversation may be a chat interaction and may be on a mobile device and may not be on an application but be on a subset of an application.

The chatbot platform may execute one or more artificial intelligence models (i.e. AI models 908) to generate chatbot responses during a conversation or exchange between the entity and the chatbot. An exchange between AI models 908 and the entity may include an interactive process where the entity communicates one or more queries, requests, and/or thoughts, and the AI models 908 respond with relevant information, solutions, and/or insights. The exchange may include all types of interactions or contextually bounded interactions. Although the aspects herein describe an AI assistant chatbot, the techniques described herein may apply to other AI models 908, such as for example, natural language processing engines, expert systems, generative AI engines, robotics engines, etc. In addition, the chatbot platform may also execute the one or more AI models 908 on a state of the chat conversation to identify attributes of the conversation and ensure that user satisfaction remains consistent throughout the conversation.

In this example, the chatbot platform may use one or more of the AI models 908, for example, an ensemble of AI models 908, to generate different chatbot responses to satisfy the entity. For example, the AI models 908 may include different algorithms, different training data, different input data, or the like, which enable the AI models 908 to output different chatbot responses.

In the examples described herein, an AI model 908 may be a “generative” AI (GenAI) model, such as a large language model (LLM) or a multimodal large language model. As another example, the GenAI model may be a transformer neural network (“transformer”), or the like. The AI model 908 may be trained to generate responses to one or more queries from the entity. The AI model 908 may include libraries and/or deep learning frameworks that enable the AI model 908 to create relevant content.

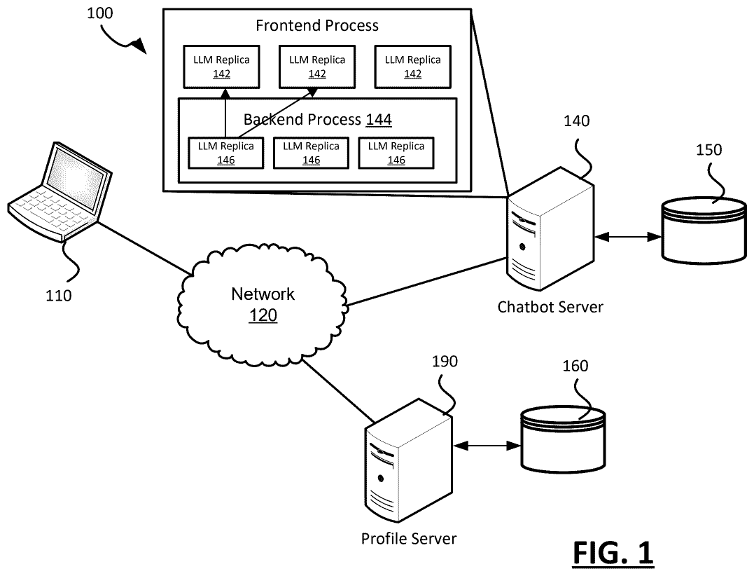

FIG. 1 is a schematic diagram of an operating environment in accordance with aspects of the present disclosure. FIG. 1 illustrates components of a chatbot system 100, including one or more client devices 110, a chatbot server 140, a database 150, a profile server 190, and a secure logical storage area 160. The components of chatbot system 100 may be configured to provide, in conjunction, various functionalities associated with an online platform. More particularly, the chatbot system 100 may provide an online chatbot platform (or application, portal, etc.) receiving one or more queries and responding with one or more responses that can be accessed using a client device 110. The client device 110 may be a remote device (e.g. remotely located) from the chatbot server 140 and/or the profile server 190.

The chatbot server 140 may be connected to the client device 110 and the profile server 190 via the network 120. The client device 110, the chatbot server 140, and the profile server 190 may be in geographically disparate locations. Put differently, the client device 110 may be remote from one or both of the chatbot server 140 and the profile server 190. In some aspects, the profile server 190 and the chatbot server 140 may be at the same geographic location. In some aspects, the profile server 190 and the chatbot server 140 may be part of a cloud configuration. For instance, the profile server 190 and/or the chatbot server 140 may be virtualized and may comprise one or more shared resource pools.

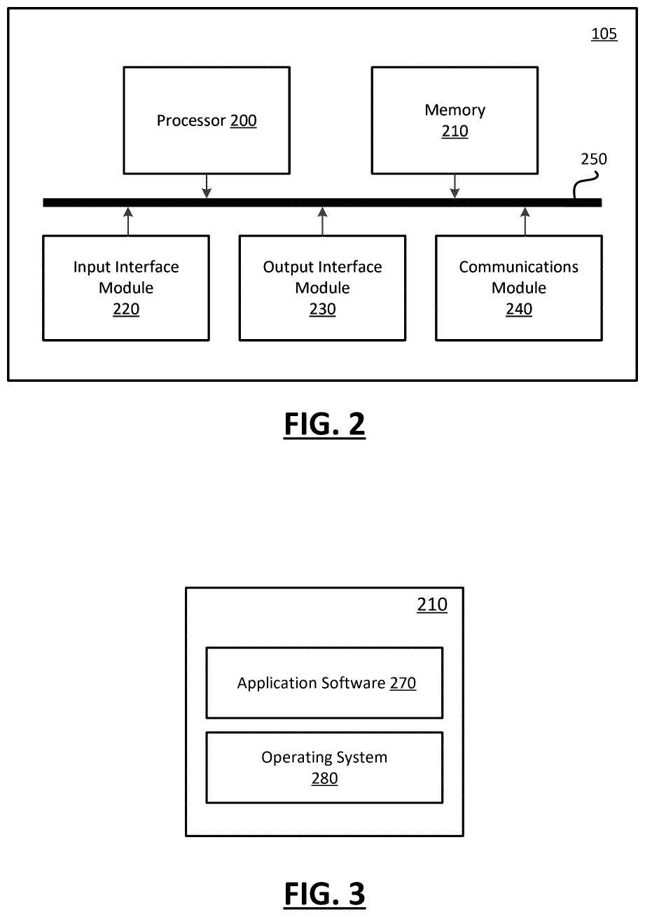

The client device 110, the chatbot server 140, and the profile server 190 are computer systems, such as those described with reference to FIG. 2 below. The client device 110 may take a variety of forms including, for example, a mobile communication device such as a smartphone, a tablet computer, a wearable computer (e.g. head-mounted display, smartwatch, etc.), a laptop or desktop computer, and/or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

FIG. 2 is a high-level operation diagram of the computing device 105. In some aspects, the computing device 105 may be exemplary of one or more of the client devices 110, the chatbot server 140, and/or the profile server 190. The computing device 105 includes a variety of modules. For example, as illustrated, the computing device 105, may include a processor 200, a computer-readable memory 210, an input interface module 220, an output interface module 230, and a communications module 240. As illustrated, the foregoing example modules of the computing device 105 are in communication over a bus 250.

The processor 200 is a hardware processor. The processor 200 may, for example, be one or more ARM, Intel x86, PowerPC processors or the like.

The computer-readable memory 210 allows data and/or instructions to be stored and retrieved. The computer-readable memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the computing device 105.

The input interface module 220 allows the computing device 105 to receive input signals. Input signals may, for example, correspond to input received from a user. The input interface module 220 may serve to interconnect the computing device 105 with one or more input devices. Input signals may be received from input devices by the input interface module 220. Input devices may, for example, include one or more of a touchscreen input, keyboard, trackball, voice command interface, or the like. In some aspects, all or a portion of the input interface module 220 may be integrated with an input device. For example, the input interface module 220 may be integrated with one of the input devices.

The output interface module 230 allows the computing device 105 to provide output signals. Some output signals may, for example allow provision of output to a user. The output interface module 230 may serve to interconnect the computing device 105 with one or more output devices. Output signals may be sent to output devices by an output interface module 230. Output devices may include, for example, a display screen such as, for example, a liquid crystal display (LCD), a touchscreen display. Additionally, or alternatively, output devices may include such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the output devices.

The communications module 240 may be coupled to the computing device 105 and may allow the computing device 105 to communicate with other electronic devices and/or various communications networks. For example, the communications module 240 may allow the computing device 105 to send or receive communications signals. Communications signals may be sent or received according to one or more protocols or according to one or more standards. For example, the communications module 240 may allow the computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 240 may allow the computing device 105 to communicate using near-field communication (NFC), via Wi-Fi™, using Bluetooth ™ or via some combination of one or more networks or protocols. In some embodiments, all or a portion of the communications module 240 may be integrated into a component of the computing device 105. For example, the communications module 240 may be integrated into a communications chipset.

Software comprising instructions is executed by the processor 200 from a computer-readable medium. For example, software may be loaded into random-access memory from persistent storage of computer-readable memory 210. Additionally, or alternatively, instructions may be executed by the processor 200 directly from read-only memory of computer-readable memory 210.

FIG. 3 depicts a simplified organization of software components stored in computer-readable memory 210 of the computing device 105. As illustrated these software components include an operating system 280 and a software application 270. The operating system 280 is software. The operating system 280 allows the software application 270 to access the processor 200, the computer-readable memory 210, the input interface module 220, the output interface module 230 and/or the communications module 240. The operating system 280 may be, for example, Apple's iOS™, Google's Android™, Linux™, Microsoft's Windows™, or the like.

The software application 270 adapts the computing device 105, in combination with the operating system 280, to operate as a device performing particular functions. For example, the software application 270 may cooperate with the operating system 280 to adapt a suitable aspect of the computing device 105 to operate as the client device 110, the chatbot server 140, the profile server 190.

While one software application 270 is illustrated in FIG. 3, in operation, the computer-readable memory 210 may include more than one software application 270, and the software applications 270 may perform different operations. For example, in aspects where the computing device 105 is functioning as a client device 110, the software application 270 may comprise a value transfer application which may, for example, be a personal banking application. The value transfer application may be configured for secure communications with the profile server 190 and may provide various banking functions such as, for example, display of account balances, transfers of value (e.g. bill payments, money transfers), and other account management functions. The software application 270 may provide a chat window that receives chat responses from the chatbot server 140. As one example, the software application 270 may be a financial-based software application that includes access to one or more financial accounts of an entity.

As illustrated, a chatbot server 140 and client device 110 communicate via a network 120. The client device 110 is a computing device 105 that may be associated with an entity, such as a user or client, having a secure logical storage area 160 of the profile server 190. The secure logical storage area 160 may comprise secure data, such as profile data, one or more entity records, one or more transfer records, etc. The secure logical storage area 160 may be provided internally within the profile server 190 or externally. In some aspects, the secure logical storage area 160 may be provided remotely from the profile server 190. For example, the secure storage may include one or more data centers. The data centers may, for example, store data with bank-grade security, such as end-to-end encryption, encrypted storage, two-factor authentication. The profile server 190 may provide access to the secure logical storage area 160 of the entity to the chatbot server 140 in response to the queries received from the client device 110 to facilitate responding to the queries. The profile server 190 may restrict data provided from the secure logical storage area 160 to the chatbot server 140 based on one or more security settings associated with and/or set by the entity via the client device 110.

The secure logical storage area 160 stores secure data. The secure logical storage area 160 may be logically partitioned into a plurality of accounts, each account associated with an entity and storing profile data associated with the entity. In particular, the secure logical storage area 160 may include records for accounts that are associated with various entities. That is, the secure data may comprise account data for one or more specific entities. For example, an entity that operates the client device 110 may be associated with an account having one or more records in the secure logical storage area 160. In at least some embodiments, the records may reflect a quantity of stored resources that are associated with an entity. Such resources may include owned resources and/or borrowed resources (e.g. resources available on credit). The quantity of resources that are available to or associated with an entity may be reflected by a balance defined in an associated record.

For example, the secure data in the secure logical storage area 160 may include financial data, such as banking data (e.g. bank balance, historical transactions data, etc.) and investment data (e.g. portfolio information) for an entity. In particular, the profile server 190 may be a financial institution (e.g. bank) server and the entity may be a customer of the financial institution which operates the financial institution server. The financial data may, in some embodiments, include processed or computed data such as, for example, an average balance associated with an account, an average spending amount associated with an account, a total spending amount over a period, or other data obtained by a processing server based on account data for the entity. In another example, the secure data in the secure logical storage area 160 may include health data, such as a patient's medical history, treatments, current conditions, prescriptions, vaccine status, etc.

In some embodiments, the secure logical storage area 160 may be a computing device 105 that includes one or more database servers, computer servers, and the like. In some embodiments, the secure logical storage area 160 may comprise an application programming interface (API) for a web-based system, operating system, database system, computer hardware, or software library.

The software application 270 on the client device 110 may establish a connection, such as a secure network connection, with the chatbot server 140 and/or the profile server 190. The secure connection may be established by the client device 110 uploading a personal identification number (PIN), biometric scan, password, username, secure sockets layer (SSL), transport layer security (TLS) handshake, etc. In response to an activation of a chatbot function of the software application 270, the chat window may be displayed on a user interface of the client device 110. In this example, the chat window may include an opening phrase, a message input by the entity, and/or a chatbot response.

In this aspect, the client device 110 may include a user interface presented by the output interface module 230 which can display a chat window which includes a chatbot that can output chat responses within the chat window from the chatbot server 140 in response to input such as requests, comments, queries, questions, and/or the like. Other aspects may have the client device 110 receive input via a microphone and responses via a sound system. The chatbot displayed on the output interface module 230, such as a display, may include an avatar, a picture, an icon, or the like, which may be displayed within the chat window when a new chat response is generated and provided to the client device 110 by the chatbot server 140. In some aspects, the chatbot displayed may be a video-generated avatar capable of movement and motion.

The entity may input messages or queries using their client device 110 into the chat window using the input interface module 220, such as using input buttons, keyboard, microphone, etc. For example, the entity inputs a query, such as asking for an account balance. The query may include operations, such as transferring data from one account to another account. The software application 270 may pass the query to the chatbot server 140, which may generate a chatbot response to the query. The chatbot responses may be generated by one or more AI engines 906 as described below. To generate a chatbot response, the AI engine 906 may receive conversational content entered into the chat window, including messages input by the entity and received responses messages from the chatbot server 140. The AI engine 906 may use historical conversation content from a database 150 and/or profile data from a secure logical storage area 160. In some aspects, the historical conversation content may include historical conversations of the entity and/or of other entities of the software application or other software applications as described in more detail below. The profile data may include account information such as financial account information, health information, transaction history, etc.

The software application 270 executing on the client device 110 may control the interaction of the chatbot server 140. In this example, the software application 270 may extract content from the chat window and provide the content over the network 120 to the chatbot server 140. In some aspects, the software application 270 may extract an entire conversation between the chatbot and the entity from the chat window. In some aspects, the conversation may be broken into an opening phrase, one or more messages, and one or more chatbot responses. As another example, the software application 270 may extract a subset of the conversation but not the entire conversation, such as an initial portion of the conversation, a current communication, and/or some other portion of the conversation, and provide the subset of the conversation to the chatbot server 140 to generate a response.

One or more AI engines 906 executing on the chatbot server 140 generate a chatbot response in response to the query from the client device 110 and outputs the chatbot response to the client device 110 for display in the chat window. The client device 110 may provide another query into the chat window, which is transmitted to the chatbot server 140 whereby the query is provided to the AI engine 906 and so forth. For example, a software application 270 for communication (i.e. a communication application) can, in response to receiving an input from the entity representing a question for the AI engine 906 and provide the question to the AI engine 906 over the network 120. The AI engine 906, with context established based on a historical context and system prompt previously received from the software application 270 for communication, may formulate an answer to the question and provide the answer to the software application 270 for communication. The software application 270 for communication can update in response to information received from the AI engine 906. For example, the software application 270 for communication can update an application interface to display the answer to the entity. In another example, the software application 270 for communication may perform text to voice generation of the received textual response. The entity can use the software application 270 for communication to process the interaction using the answer received from the AI engine 906 (e.g., to respond to the entity, provide information to the entity, interact with one or more backend systems to update an account, etc.).

In some aspects, the software application 270 may extract the exchange (e.g., the opening phrase, the message, the chatbot response, etc.), and transmit the extracted exchange to the chatbot server 140. The chatbot server 140 may generate a new chatbot response. The new chatbot responses may transmitted to the client device 110 to be output in sequence in the chat window.

The software application 270 for communication may act as an event generator by capturing events performed in the software application 270 for communication, such as interactions with the AI engine 906. For example, the software application 270 for communication may provide generated events to an event store. The events may be dynamically sent to the AI engine 906 so that the AI engine 906 may dynamically update the context with events generated by the software application 270 for communication as well as with query-response information the AI engine 906 has generated for the software application 270 for communication. Accordingly, the AI engine 906 can provide up to date and accurate answers to further questions that may sent to the AI engine 906 during the interaction.

The AI engine 906 may use responses from the current session to facilitate responses. In some aspects, the AI engine 906 may also use previous conversation sessions, including the previous messages. The AI engine 906 may generate a response based on a total conversation with the entity and not just a current input.

In some aspects, the context may include provided by the software application 270 for communication from the client device 110. A context prompt may be used to establish context for the AI engine 906. The example context prompt may include a summary of previous interactions that may include salient details of the previous interactions or exchanges. Each item in the summary may include a context string. In some aspects, the summary may comprise one or more embeddings and/or vectors. The summary may comprise all relevant points of exchanges, a portion of the relevant points of the exchanges, and/or one or more of the relevant points of the exchanges. The AI engine 906 may be trained to determine what may be relevant points based at least on the field of the AI engine 906. For example, when the AI engine 906 applies to a resource management application, the AI engine 906 may identify transfers between accounts as relevant to include in the summary. Other examples are described in further detail herein. In some aspects, the AI engine 906 may determine relevancy based, in part, on what the entity interacting with the AI engine 906 considers to be relevant.

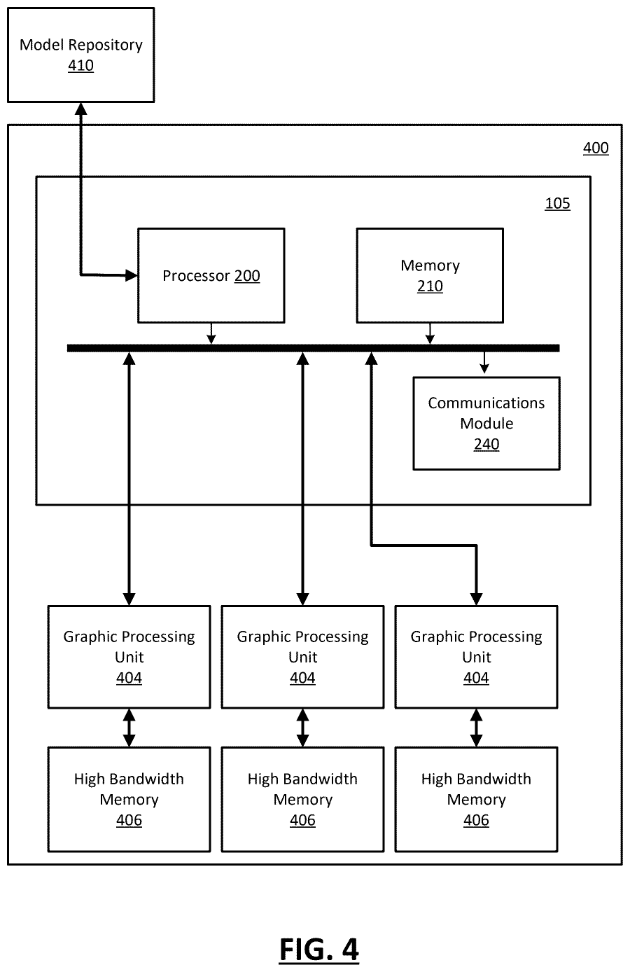

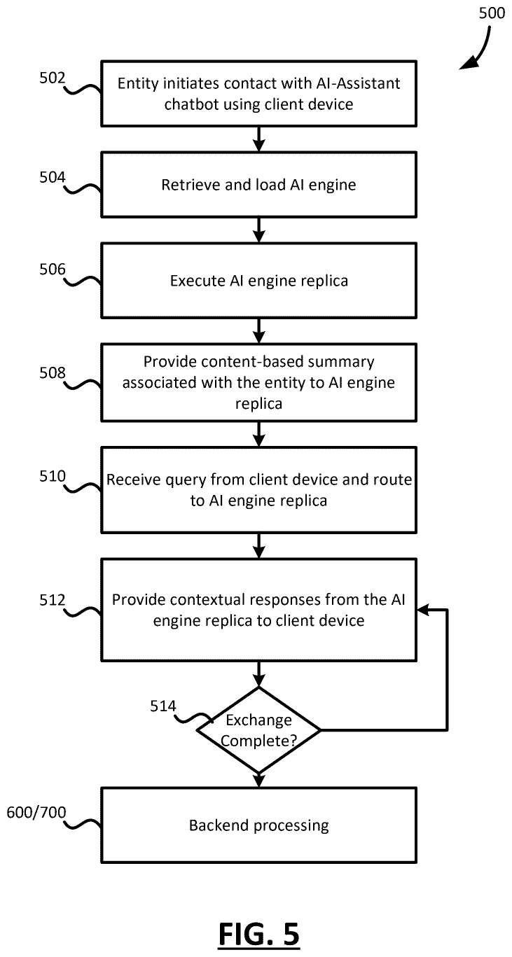

With reference to FIGS. 4 and 5, when the entity interacts with the AI-assistant chatbot (at step 502) in the chat window, the entity typically expects the chatbot to have knowledge of previous interactions with the chatbot. AI engines 906 may exhibit significant performance degradation when a previous exchange or exchanges is/are provided to the AI engine 906. For example, the amount of data storage for an LLM to load in memory can increase in a quadradic fashion. For example, a piece of text that is 8-MB may consume 84 MB (i.e., roughly 4 GB) to store in an LLM. As such, LLMs may experience degradation when attempting to self-reference conversations and/or long-term conversations in a single exchange and/or across several exchanges. As described herein, the aspects may alleviate these performance degradations.

Turning to FIG. 4, the chatbot server 140 may execute one or more artificial intelligence (AI) assistant chatbots and/or one or more backend processes 144. In this aspect, the AI-assistant chatbots may be an AI engine 906 that may comprise one or more replicas of an AI model, such as an LLM. As described herein, a frontend LLM replica 142 is an instance of the LLM executing on parallel processing hardware, such as a graphics processing unit array (i.e. GPU array 400). The GPU array 400 may comprise the computing device 105 as previously described. In some aspects, the computing device 105 may comprise the processor 200, the computer-readable memory 210, and the communications module 240.

The GPU array 400 may comprise a plurality of GPUs 404 having a plurality of the high-bandwidth memory 406 associated therewith. In this example, three GPUs 404 and high-bandwidth memory 406 are shown. Other aspects may have more or fewer GPUs 404 and more or fewer high-bandwidth memory 406 associated with the GPUs 404. The process 500 may begin when the AI engine 906 may be created when the entity initiates contact using the client device 110 with the chatbot server 140 at step 502. The GPU array 400 may retrieve the AI engine 906 from a model repository 410 and load the AI engine 906 into the high-bandwidth memory 406 at step 504. In some aspects, the AI engine 906 may comprise one or more frontend LLM replicas 142 and the frontend LLM replicas 142 may be a large language model loaded from the model repository 410 into the high-bandwidth memory 406 for execution. The GPU 404 may execute the AI engine 906 (or in the case of frontend LLM replicas 142, multiple GPUs 404 may execute the frontend LLM replicas 142) at step 506 prior to receiving the queries. In some aspects, a previously executing AI engine 906 (or the frontend LLM replica 142) that is no longer being used may be reset (or reloaded) in preparation for the new interaction. In an aspect, the GPU array 400 may be provided with a content-based summary associated with the entity to the AI engine 906 at step 508 as described in further detail below.

The processor 200 may execute a software application 270 from the computer-readable memory 210 to manage the GPU array 400. The software application 270 may include an application programming interface (API) call or other submission identifier to provide the query data from the client device 110 to the AI engine 906 executing by one (or more) of the GPUs 404. The API may comprise an identifier of the AI engine 906 to execute, a payload of query data, an expected output, a storage location for the expected output, an account identifier, an identifier of the profile server 190, security data, etc. Some aspects may not permit the API specifying the AI engine 906 to execute and, in this manner, the software application 270 determines which AI engine 906 to execute. The processor 200 may receive one or more queries comprising the query data from the communications module 240 and provide responses comprising response data to the communications module 240.

In some aspects, the payload of query data may be in a format that may be incompatible with an input to the AI engine 906. For example, the payload of query data may be in text format, image format, audio format, and the like, such as content from a web page or other format where articles are displayed publicly on the Internet. In response, the processor 200 may initiate a query payload conversion process, such as chunking described below, to convert the query data into a format that is suitable for the AI engine 906, such as chunks, a vector, or other encoding. In some aspects, the processor 200 may initiate a translation conversion process to translate a foreign language of the query data into a language that the frontend LLM replica 142 has previously been trained. The translation conversion process may convert the response from the AI engine 906 back into the originating language to transmit the response in the originating language to the client device 110.

The AI engine 906 replica may receive one or more queries from one or more entities via client devices 110 associated with their respective entities at step 510 and in some aspects may be routed by the processor 200 to the GPU 404 executing the AI engine 906. The processor 200 may execute a frontend distributing module that may comprise instructions to send, transmit, and/or distribute data related to a query to at least one of the GPUs 404. The frontend distributing module may monitor a workload of the GPUs 404 to select the GPU 404 with available capacity. For example, the GPUs 404 may periodically post workloads to the distributing module (e.g. approximately 15-minute intervals) via an application interface. The frontend distributing module may determine that one of the GPUs 404 has a low workload, or workload below a threshold, and in response, distribute queries to that one of the GPUs 404. In some aspects, the distributing module may cooperate with a priority module to assign to the GPUs 404 a higher or greater priority before lower or lesser priority data transfers.

The processor 200 may execute a backend distributing module that may comprise instructions to send, transmit, and/or distribute data related to background processing to backend processes 144 executing on at least one of the GPUs 404. The backend distributing module may monitor a workload of the GPUs 404 to select the GPU 404 with available capacity. For example, the GPUs 404 may periodically post workloads to the distributing module (e.g. approximately 15-minute intervals) via an application interface. The backend distributing module may determine that one of the GPUs 404 has a low workload, or workload below a threshold, and in response, distribute background processing tasks to that one of the GPUs 404. In some aspects, the distributing module may cooperate with a priority module to assign to the GPUs 404 a higher or greater priority before lower or lesser priority data transfers.

In other aspects, the client device 110 may communicate directly with the GPU 404 executing the AI engine 906. The AI engine 906 may provide contextual responses to the queries and the responses may be provided to the processor 200 for relaying to the client device 110 at step 512. The exchange may continue until complete at step 514. In some aspects, the AI engine 906 may comprise one or more frontend LLM replicas 142 to process the queries received from entities and one or more backend LLM replicas 146 to perform one or more of the backend processes as described herein. The backend LLM replicas 146 may be shared among the frontend LLM replicas 142 that are processing the entity queries.

In some aspects, the backend process 144 may store conversation history data associated with an exchange in a database 150. For example, the backend process 144 may store the conversation history data in a text file and/or the backend process 144 may append a current query session comprising one or more queries to the text file with a timestamp. In some aspects, each of the queries may have an associated timestamp. In other aspects, a single timestamp may be associated with the query session. In another example, the backend process 144 may store the query sessions in their own respective text file.

In some aspects, the conversation history data may include previous exchanges between the client device 110 associated with the entity and the chatbot server 140. The complete conversation history data may be stored in a long-term storage repository (not shown) separate from the database 150 and the chatbot server 140. The complete conversation history data may be sizeable depending on the number of exchanges between the client device 110 and the chatbot server 140. The complete conversation history data may be compressed. The complete conversation history data may be stored for auditing purposes, such as determining errors in training of the AI engine 906. In some aspects, a user identifier may be used to retrieve the complete conversation history data from the long-term storage repository of previous interactions with the entity.

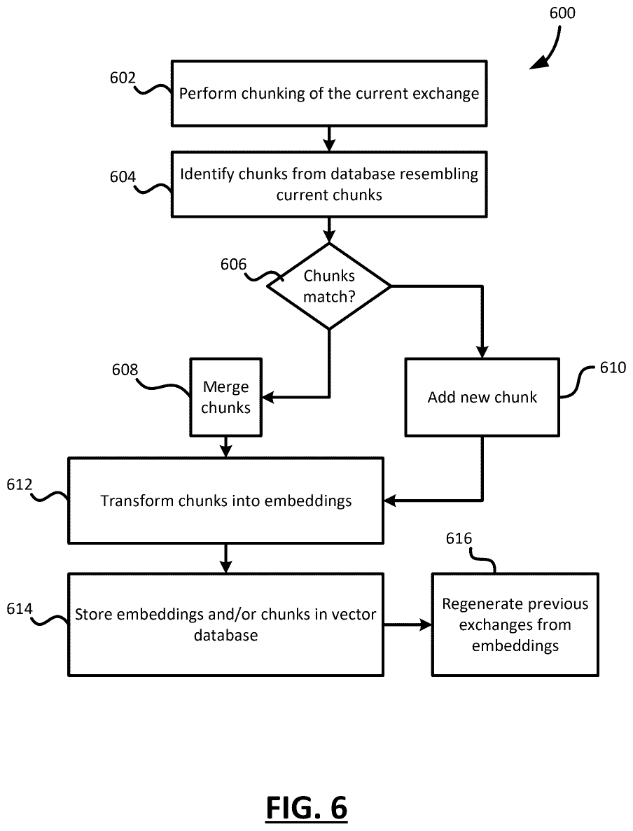

Turning to FIG. 6, in an aspect, the backend process 144 may comprise a chunking process that may break the exchange (e.g. the text file) into one or more chunks at step 602. The chunking process may perform a content-aware chunking by segmenting the exchange into sentences split the exchange into sentences, such as using a sentence tokenizer. The sentence tokenizer may detect punctuation marks, such as periods, exclamation points, and/or question marks, to identify an end of a sentence. The sentence tokenizer may have one or more contextual rules, such as handing exceptions like abbreviations (e.g., “Dr.”, “Mr.”, “Ms.”, etc.). The sentence tokenizer may be customized for the particular language as some languages have different punctuation and/or sentence structure rules. In another aspect, the chunking process may split the exchange into query and response pairs. In some aspects, a backend LLM replica 146 may be provided with the exchange along with a query to segment the exchange into context-aware chunks.

The chunking process may identify one or more chunks resembling a current chunk and/or the query from a previous query at step 604. In an aspect, the identification process may involve comparing the current chunk to chunks from previous exchanges. In another aspect, the identification process may involve comparing the current chunk to any previous exchanges including the current exchange. In some aspects, the contextually-similar chunk (e.g. chunks with the same meaning) may be determined based on a content similarity between the current chunk and the previous chunks. When the content similarity exceeds a similarity threshold at step 606, the identification process selects the chunk for merging with the current chunk at step 608. In an aspect, the content similarity may be determined only for the query portion of the chunk in that similar queries may be more likely to result in similar responses. When the content similarity does not exceed the similarity threshold, a chunk creation process may generate a new chunk at step 610 to be added to the conversation history data to be stored in the database 150 at step 614. In an aspect, the previous chunks and the current chunk may be provided to the backend LLM replica 146 with an inquiry to determine the contextual similarity between the previous chunks and the current chunk.

In an aspect, one or more of the similar chunks as determined using the contextual similarity threshold and the current chunk may be provided to the backend LLM replica 146 with a query to determine which of the similar chunks corresponds to the current chunk. In another aspect, the previous chunks and the current chunk may be provided to the backend LLM replica 146 with an inquiry as to which previous chunk is contextually similar to the current chunk.

When the similar chunk(s) are selected, a merging process may merge the current chunk with one or more similar chunks to form a merged chunk. In some aspects, the current chunk may replace the similar chunk. In another aspect, the current chunk may be discarded, and the similar chunk may remain in place. In yet another aspect, the merging process may be the backend LLM replica 146 that may determine whether the current chunk and the similar chunk is to be merged. In yet another aspect, the merging process may be the backend LLM replica 146 that may merge the content of the current chunk with the similar chunk. In some aspects, the chunks may be stored in the database 150.

The chunks (merged or otherwise) may be converted into an embedding at step 612. In an example, the chunk may be tokenized by splitting the chunks into smaller units referred to as tokens. The tokens may be words, sub-words, and/or characters. The tokenizer may be a word tokenizer, a sub-word tokenizer, a character tokenizer, a sentence tokenizer, a whitespace tokenizer, and/or any custom tokenizer. The word tokenizer may split the chunks into individual words. The sub-word tokenizer may break the chunks into smaller units than words, such as sub-words (e.g. unhappiness may be broken into “un”, “happi”, “ness”) or morphemes (e.g. rebuilding may be broken into “re”, “build”, “-ing”). A morpheme may be a smallest meaningful unit in a language with semantic meaning. A sub-word may not always carry a standalone meaning. In another example, the word “unbelievable” may be broken down using morphemes as “un-”, “believe”, “-able” whereas a Byte Pair Encoding may break the word into sub-words “un”, “bel”, “iev”, “able”. The character tokenizer may split text into individual characters for languages with complex morphology (e.g. Finnish, Turkish, Arabic, Hebrew, Russian, etc.) and/or for fine-grained text analysis. The sentence tokenizer may be similar to the one previously described with reference to chunking. The whitespace tokenizer may split text based on whitespace characters.

When the chunks have been tokenized into tokens, the tokens are then converted into a dense vector of fixed size. The tokens may be provided to an embedding layer that maintains an embedding matrix of size V x D, wherein V is a vocabulary size and D is an embedding dimension for the vector. The embedding matric contains a vocabulary of unique tokens in an indexed dataset. The embedding layer may map each token to a high-dimensional space whereby positional encodings may be added to the token embeddings. A self-attention process may weigh the token embeddings in relation to others in the sequence enabling the embedding process to focus on relevant parts of the chunks when generating the embeddings. In some aspects, the embedding process may be a feed-forward neural network or a transformer having a number of layers to refine the representations of the embeddings.

In some aspects, a list of the embeddings may be stored in the database 150, such as a vector database, at step 614. In an aspect, the database 150 may then be used to determine the context-based summary for the AI engine 906 replica in exchanges between the entity via the client device 110 and the chatbot server 140, such as for step 508. In some aspects, the embeddings from a secure logical storage area 160 associated with one entity may be compared with the embeddings from another secure logical storage area 160 associated with a different entity using the backend LLM replica 146 for a consistency, such as for example, when the entity query includes questions regarding terms and conditions for their accounts on the profile server 190 and/or the chatbot server 140. In some aspects, the summary may include prompt to the backend LLM replica 146 to generate one or more headings to summarize the interaction (e.g., described in the context prompt) from a customer's perspective.

In some aspects, the conversation history may be generated using a reverse process at step 616 by selecting a set of embeddings and converting the set into a generated text conversation using the backend LLM replica 146. In this aspect, the backend LLM replica 146 may comprise an encoder component and a decoder component, such as a transformer model. The encoder component may generate the embeddings from the chunks, such as at step 612. Each layer in the encoder may apply self-attention and feed-forward neural networks to transform the input embeddings into more abstract representations. The decoder may generate the text from the set of embeddings. The generated text conversation may then be transmitted to the client device 110 for display. The decoder may generate the output sequence by attending to both the input representations from the encoder and the previously generated tokens.

In some aspects, the backend LLM replica 146 may provide a greeting message to the communication application executing on the client device 110 and may then provide the summary of the regenerated conversation history to the communication application. In some aspects, the greeting message and the regenerated conversation history may be limited to approximately 300-words. In other aspects, the length of the greeting message and the regenerated conversation history may be limited to one or more screens of text depending on a type of the client device 110, such as a single screen on a desktop computer or laptop, or three screens on a mobile device. In some aspects, the greeting message and/or the regenerated conversation history may be provided on a customer service agent device whereby the customer service agent may assist the entity in accomplishing a customer service activity, such as when a customer service agent takes over from a self-service chatbot.

The database 150 may be used to provide context to the frontend LLM replica 142 about one or more past exchanges. For example, when a query is received from the client device 110 by the chatbot server 140, then the processor 200 may preprocess the query by transforming the query into an embedding as previously described. The processor 200 may then find the embedding in the database 150 that resembles the embedding from the query. The processor 200 may provide the similar embedding to a dechunking process to convert the similar embeddings back into one or more chunks. In an aspect, the dechunking process may be a decoder for the backend LLM replica 146. These chunks may be provided to the frontend LLM replica 142 to produce an answer the question based, at least in part, on the previous conversation.

In another aspect, a content-based summary of one or more of the exchanges with the chatbot server 140 may be generated. For example, the content-based summary may be generated after the exchange. The current exchange may be provided to the backend LLM replica 146 with a request that the backend LLM replica 146 perform a content-based summarization of the current exchange. The summarizing frontend LLM replica 142 may be an LLM, such as a multimodal LLM. As another example, the summarizing frontend LLM replica 142 may be a transformer neural network (“transformer”) or the like. A language model may use a neural network, such as a deep neural network (DNN) to perform natural language processing (NLP) tasks such as language translation, image captioning, grammatical error correction, and natural language generation, among others. A language model may be trained to learn parameters to model how words relate to each other in a textual sequence, based on probabilities. A language model may contain hundreds of thousands of learned parameters and/or in the case of an LLM may contain millions or billions of learned parameters or more. In this manner, the summarizing frontend LLM replica 142 may learn the patterns and structure of their input training data and then generate new content that has similar characteristics.

In some aspects, the content-based summary may be provided via the network 120 to the client device 110. In some aspects, the client device 110 may present the content-based summary via the output interface module 230 with a prompt asking the entity to confirm an accuracy of the content-based summary via the input interface module 220. The database 150 may store the content-based summary. In this manner, the database 150 may store a plurality of the content-based summaries for each exchange between the entity and the AI-assistant chatbot. The database 150 may associate these summaries with an account for a secure logical storage area 160 associated with a particular entity.

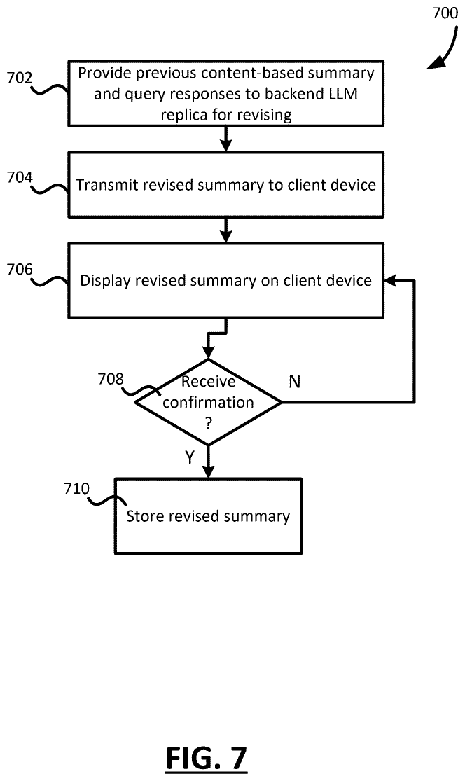

In another aspect as shown with reference to FIGS. 5 and 7, the content-based summary may include all previous exchanges with the AI-assistant chatbot. When the entity accesses the chatbot server 140 using the client device 110, the processor 200 of the chatbot server 140 may retrieve the content-based summary associated with the entity from the database 150, such as at step 508. In some aspects, the chatbot server 140 may receive additional contextual data in addition to the historical chat content. The additional contextual data may include conversations labeled with a tone, conversations labeled as insufficient or unrelated, conversations labeled with a topic of interest, and the like.

The content-based summary may be provided to the frontend LLM replica 142 executing on the GPU 404. The content-based summary may be a plurality of embeddings that may be converted to chunks with the backend LLM replica 146. The chunks may be provided to the frontend LLM replica 142. The frontend LLM replica 142 may receive one or more queries from the client device 110 via the communication module 240 such as at step 510. The frontend LLM replica 142 may identify a portion or the entirety of the summary that resembles the query and may answer the query with a response such as at step 512. In some aspects, the query may be converted to a query embedding and the portion of the summary that resembles the query may be determined based on the query embedding resembling the embeddings from the summary. When the exchange is complete at step 514, the backend processing may perform the steps as shown in FIG. 7.

The content-based summary may be revised by process 700 based on the response in conjunction with the previous content-based summary to provide a revised content-based summary. In some aspects, the revised summary may be generated by providing the content-based summary and the response to the backend LLM replica 146 at step 702. The revised summary may be transmitted via the network 120 to the client device 110 at step 704. The revised summary may be provided on the client device 110 via the output interface module 230 with a prompt asking the entity to confirm an accuracy of the revised summary at step 706. When the chatbot server 140 received an accuracy confirmation at step 708, the chatbot server 140 may perform the backend process 600 and/or may store the revised summary to the database 150 at step 710. When the chatbot server 140 receives a query disputing the accuracy of the summary, the chatbot server 140 may revise the revised summary and/or prompt the entity on which portions of the revised summary were inaccurate whereby the entity may provide feedback via the client device 110. In some aspects, the revised summary may be compared to the previous summary on the client device 110 to facilitate the entity in observing the revisions performed on the previous summary. The summary may comprise event data for the events that have previously occurred in the interactions. The event data may include operation prompts for executing processes on the profile server 190.

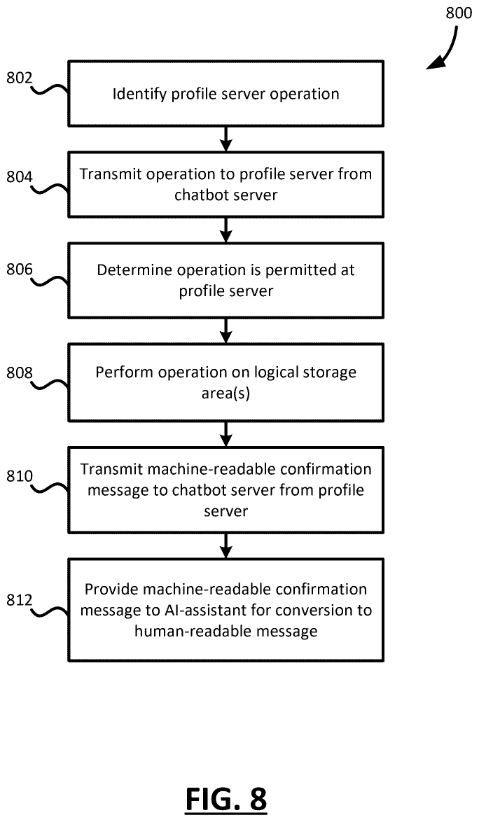

With reference to FIG. 8, when the query involves providing operations to the profile server 190, the processor 200 of the chatbot server 140 may execute the process 800 by identifying the operation at step 802, such as a transfer of data from one secure logical storage area 160 to another secure logical storage area 160. The processor 200 may provide the operation securely over the network 120 to the profile server 190 at step 804. In some aspects, the profile server 190 may comprise an event queue receiving the operations associated with one or more profiles. The operations may be queued in receipt order to be executed by an event execution process executing on the processor 200 of the profile server 190. The profile server 190 may execute instructions using its processor 200 to confirm that the operation is permitted at step 806. A security process may approve the operation based on, for example, whether the operation adheres to one or more organizational policies, and/or whether fraud results from executing of the operation.

The profile server 190 may perform the operation at step 808 and send a machine-readable confirmation message to the chatbot server 140 at step 810. The chatbot server 140 may provide the machine-readable confirmation message to the frontend LLM replica 142. The frontend LLM replica 142 (or backend LLM replica 146) may transform the machine-readable confirmation message into a human-readable message, which may be transmitted to the client device 110 at step 812 and/or included in the summary of the exchange. The successful operation may be provided AI engine 906 to include the operation in the contextual summary as previously described. As another example, the human-readable message may be a human-readable greeting that can be spoken by a contact center agent to the entity.

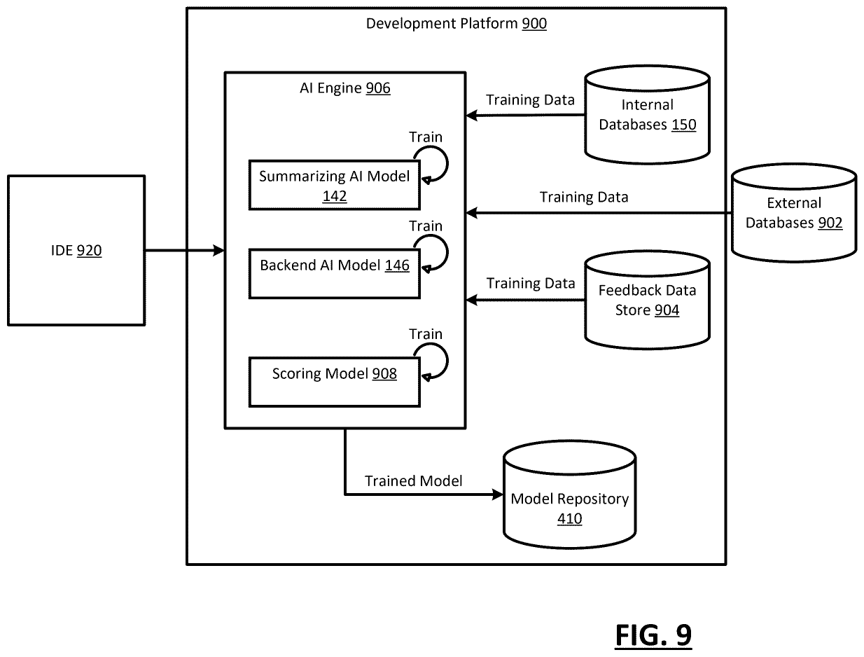

Turning to FIG. 9, an AI development platform 900 is shown for training the AI engine 906 to generate chatbot responses and/or generate exchange summaries. An integrated development environment (i.e. IDE 920) may enable a provider to develop, train, and/or retrain the AI engines 906. The IDE 920 may include a software application 270 with a programming interface accessible by a developer device (not shown), which may be a computing device 105, over the network 120 or via a local connection. The IDE 920 may be a web application that can be accessed at a network address, uniform resource locator (URL), etc. The IDE 920 may be locally or remotely installed on a computing device where the IDE 920 is accessed and used locally.

The IDE 920 may be used to design an AI engine 906 using the user interface of the IDE 920. For example, the user interface may be output as part of the software application that interacts with the IDE 920. A developer may use an input mechanism to make selections from menus to add pieces to the AI engine 906, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI engine 906 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 920 can save the model for subsequent training and/or testing.

For example, the frontend LLM replica 142 may receive text as input and generate responses displayed on in the IDE user interface. The frontend LLM replica 142 may be trained to determine a tone of a chat conversation. The frontend LLM replica 142 may be trained to determine whether the response is insufficient or unrelated. The frontend LLM replica 142 can be trained based on the training data. For example, the user interface may be used to build an AI engine 906 comprising multiple frontend LLM replicas 142 and/or backend LLM replicas 146. The AI engine 906 may be trained to generate chatbot responses through training. The AI engine 906 stored in the model repository 410 may be trained to understand and generate text based on a large corpus of documentation. The training data may include a large corpus of articles, posts, reviews, comments, and the like. Furthermore, the training data may also include user data. In the example aspects, the training data may include publicly available articles that have been crawled or otherwise obtained from a website or the like.

The training data may be provided from a training data store, such as database 150, which may include training samples from the web, from customers, and the like. As the summaries are intended to provide context, the training data may comprise training samples to train the frontend LLM replica 142 to identify factual information in the exchange and in particular, factual information regarding the profile of the entity. Additionally or alternatively, the training data may be pulled from one or more external databases 902 such as publicly available sites, etc. During the training process, the AI engine 906 may be scrape chat content from different sources, including external host servers, websites, previous chat conversations of the user and/or of other users, and the like. In some aspects, the AI engine 906 may scrape profile data during the training process, such as financial account data from the secure logical storage area 160. The AI engine 906 may be retrained on chatbot responses generated by the frontend LLM replica 142 and/or the backend LLM replica 146 and responses from the client device 110 to the chatbot responses.

In some aspects, the frontend LLM replica 142 may be trained on a chatbot conversation to determine a next chatbot response to output. In some aspects, a backend LLM replica 146 for tone (i.e. a backend tone LLM replica) may be trained to determine a conversational tone of at least one of a chat input, a sequence of chat communications, a conversation state, and the like. In this example, the frontend LLM replica 142 may generate a next chatbot response and the second backend LLM replica may modify the response based on a determined tone before outputting the response to the chat window for the client device. For example, the backend tone LLM replica may determine when the entity has an optimistic tone, a pessimistic tone, an informal tone, a formal tone, a humorous tone, etc. The AI engine 906 may combine the predicted response and the determined tone to output a final message for transmittal to the client device 110. In this manner, the chatbot server 140 may maintain a conversational flow and may make the chat conversation more contextually relevant. According to various aspects, the frontend LLM replica 142 may continue to generate responses based on the conversation state and the backend tone LLM replica may modify or otherwise rewrite the responses based on the tone determined from the conversation state. In some aspects, the backend tone LLM replica may supress and/or rewrite responses from the frontend LLM replica 142 associated with negative tones.

In some aspects, a backend LLM replica 146 (i.e. a backend sufficiency LLM replica) may determine whether the response sufficiently answers the query. The backend sufficiency LLM replica may determine whether the response answers the query or related to the conversation based on a subsequent response from the entity, a pause or lack of response, a question, or the like. In this example, the backend sufficiency LLM replica may provide feedback to the frontend LLM replica 142 to prompt a different response based on the state of the conversation prior to the insufficient or unrelated chat response being output. The feedback may be an indication of insufficiency, irrelevancy, or lack of quality. In the example aspects, multiple backend LLM replicas 146 may be combined to improve the overall prediction accuracy and robustness. In some aspects, as the backend LLM replicas 146 may execute on a different GPU than the frontend LLM replica 142, performance may be improved while mitigating weaknesses of using a single frontend LLM replica 142. In some aspects, when the backend LLM replicas 146 are shared with multiple frontend LLM replicas 142 thereby maintaining consistency between responses from the frontend LLM replicas 142 interacting with different entities.

In some aspects, a backend LLM replica 146 for security (i.e. a backend security LLM replica) may supress responses from the frontend LLM replica 142, such as when the entity inquires about topics outside of the purview of the profile associated with the entity. For example, when the entity provides a query related to another entity, the backend security LLM replica may supress the generated response from the frontend LLM replica 142 and provide a response, such as “I'm sorry but I can't respond to that inquiry.” The backend security LLM replica may determine when the entity provides queries outside of a topic of interest, namely outside of a system purpose. For example, when the chatbot server 140 operates in a financial environment, inquiries outside of financial topics are supressed by the backend security LLM replica. As the dialogue progresses, the backend security LLM replica may monitor each query and/or response to ensure adherence to the topic of interest by comparing the query and/or response to the topic of interest. When the query and/or response is determined to deviate from the topic of interest, the backend security LLM replica may generate a new chat response that is designed to steer the conversation back to the original topic of interest and/or may supress the response from the frontend LLM replica 142.

The AI engine 906 may iteratively retrieve additional training data sets from the database 150 and/or the external database 902 and iteratively input the additional training data sets into the frontend LLM replica 142 and/or the backend LLM replica 146 to continue to train the LLM. The frontend LLM replica 142 and/or the backend LLM replica 146 may continue the process until receiving instructions to terminate, which may be based on a number of iterations (e.g. training loops), total time elapsed during a training process, etc. When the frontend LLM replica 142 and/or the backend LLM replica 146 are trained to within a satisfactory error rate, the frontend LLM replica 142 and/or the backend LLM replica 146 may be stored within the model repository 410 as one of the trained models. In some aspects, the frontend LLM replica 142 and the backend LLM replica 146 may be trained independently. In other aspects, both the frontend LLM replica 142 and/or the backend LLM replica 146 may be trained together.

The training process for training and/or retraining the AI engine 906 may involve an executable script configured to read data from the database 150 and/or the external database 902 and input the data to the AI engine 906. For example, the executable script may use identifiers (IDs) of one or more data locations (e.g., table IDs, row IDs, column IDs, topic IDs, object IDs, etc.) to identify locations of the training data within the database 150 and query an API of the database 150. In response, the database 150 may receive the query, load the requested data, and return the data to the executable script, where the data is input to the AI engine 906. The training process may be managed via an interface of the IDE 920, allowing for supervised learning during the training process. In other aspects, the training process may perform unsupervised learning.

In some aspects, the script may iteratively retrieve additional training data sets from the database 150 and iteratively input the additional training data sets into the AI engine 906 during the execution to continue to train the AI engine 906. The script may continue until instructions within the script direct the script to terminate, which may be based on a number of iterations (e.g. training loops), total time elapsed during the training process, etc.

The IDE 920 may also be used to retrain the AI engine 906 after being deployed. The training process may use executional results that have been generated or output by the frontend LLM replica 142 and/or the backend LLM replica 146 in a live environment for retraining. For example, a scoring AI model 908 may score output of the frontend LLM replica 142 and/or the backend LLM replica 146 and feedback those scores to retrain the frontend LLM replica 142 and/or the backend LLM replica 146 to further enhance accuracy. The feedback may include indications of whether the generated output scores match scores resulting from a manual evaluation, such as based on the accuracy confirmation received from the entity and/or feedback on the inaccuracy of the revised summary. In yet another example, the textual summaries generated by the summarizing frontend LLM replica 142 and feedback with respect to those textual summaries may be used to retrain the summarizing frontend LLM replica 142 to further enhance its accuracy or reliability. The feedback may include indications of whether the generated textual summaries adequately summarize data transfers, based on the accuracy confirmation received from the entity and/or feedback on the inaccuracy of the revised summary. The described feedback data may be captured and stored within a feedback data store 904 or other data store within the live environment and can be subsequently used to retrain the scoring AI model 908, the summarizing frontend LLM replica 142, and/or the backend LLM replica 146.

The aspects described herein may apply to a chatbot server 140 for healthcare (i.e. a healthcare chatbot server). The AI engine 906 may be trained from patient-doctor, patient-nurse, patient-pharmacist, and/or patient-medical paraprofessional conversations and tone to predict health concerns and questions and respond accordingly. The frontend LLM replica 142 may be trained extensively with healthcare-specific dialogues, including patient-doctor interactions, inquiries, and/or various health-related discussions. The training data may encompass different medical scenarios, patient emotional states, queries about symptoms, medications, diseases, treatment protocols, and patient care guidelines and/or healthcare terminologies. The frontend LLM replica 142 may generate a more comprehensive, informative, and/or understandable response. Responses may involve offering a more detailed explanation of a medical condition, suggesting steps for care, and/or advising on medication usage in a manner that is tailored to a patient's level of understanding.

The backend tone LLM replica may be trained to understand the emotional undertones, such as anxiety, curiosity, or urgency, which are common in healthcare settings. When a patient initiates a conversation with the chatbot server 140 via their client device 110, the frontend LLM replica 142 may analyze the queries for medical content and the backend tone LLM replica may analyze the queries for emotional or tone cues. For instance, a patient expressing concern about specific symptoms may be provided with a response that addresses their medical query by the frontend LLM replica 142 and the response may be modified by the backend tone LLM replica to acknowledge their worry. Through its predictive capabilities, the frontend LLM replica 142 may anticipate follow-up questions and concerns based on the initial inquiry and provides comprehensive information accordingly. As the backend tone LLM replica identified anxiety, the frontend LLM replica 142 may include explaining possible conditions, next steps, and/or reassurances to alleviate anxiety.

The chatbot server 140 may be integrated with a profile server 190 for patients and associated secure logical storage area 160 that may store health records and/or history. Subject to privacy regulations and consent, the chatbot server 140 may access the secure logical storage area 160 and may tailor the responses more accurately, considering the patient's medical background, ongoing treatments, and/or past concerns. In some aspects when the summaries may include private health data, the summaries may be provided to the secure logical storage area 160 via the profile server 190. In this manner, the chatbot server 140 may initially retrieve the summaries from the profile server 190 to provide the context summary to the AI engine 906. Similarly, when the exchange is concluded, the summary may be revised, and the revised summary may be provided back to the secure logical storage area 160 via the profile server 190. The AI engine 906, using these contextual summaries, may personalize responses based on the patient's medical history and profile from electronic health records, ensuring that the responses provided are relevant to the individual's specific health circumstances. The chatbot server 140 may integrate with existing healthcare ecosystems, including electronic health record systems, patient management systems, and/or telehealth platforms.

For example, the frontend LLM replica 142 may provide more detailed and specific advice, reminders about medication, and/or upcoming appointments for a patient with a history of a particular condition. The AI engine 906 may support continuous learning. Each interaction may be analyzed to improve the AI engine 906 based on understanding of patient communication patterns, medical queries, and/or effective response strategies. The AI engine 906 may continue to be trained based on current medical advancements.

In some aspects, the backend LLM replica 146 may identify repeated questions, usage of uncertain terms, and/or follow-up questions that suggest the initial response did not fully resolve the patient's queries. When the backend LLM replica 146 detects an insufficient response or an unrelated response to the chat conversation with the patient, the backend LLM replica 146 may notify the frontend LLM replica 142 to provide a simpler response and/or a clearer response.

In some aspects, the AI engine 906 may make recommendations and/or changes to a treatment plan and/or prescriptions for medication. These recommendations may be transmitted as operations to the profile server 190. A medical professional may review, reject, and/or approve these recommendations at a later point and engage the AI engine 906 to include these decisions in the patient summaries. The AI engine 906 may provide these decision summaries to the patient via the client device 110 when the patient accesses the profile server 190 and/or chatbot server 140.

The aspects described herein may apply to a chatbot server 140 (i.e. an education chatbot server) for education and/or a chatbot server 140 for e-learning (i.e. an e-learning chatbot server). The AI engine 906 may be trained to assist students in an educational setting. In some aspects, the backend tone LLM replica may be trained to detect the student's tone, such as confusion, curiosity, and/or confidence, and may adjust the responses from the frontend LLM replica 142 such as teaching style and explanations. For example, a student struggling with a concept might receive responses having a more detailed, step-by-step explanation in a supportive tone. In another example, a more confident student might receive responses including challenging questions to stimulate deeper learning. The AI engine 906 may be trained with various educational dialogues and materials, ranging from textbook content to teacher-student interactions. The training of the frontend LLM replica 142 may encompass various academic subjects, educational levels, and/or learning styles. In some aspects, the frontend LLM replica 142 may comprise a plurality of frontend LLM replicas 142, each trained for a particular subject matter. The backend tone LLM replica may be trained to recognize and interpret students' different emotional states and learning attitudes, such as confusion, curiosity, enthusiasm, or frustration, as expressed in their queries.

When a student interacts with the AI engine 906, the AI engine 906 may retrieve one or more of the contextual summaries and provide these summaries to the one or more frontend LLM replicas 142 and/or one or more backend LLM replicas 146. The frontend LLM replica 142 may analyze the student's queries for educational content and the backend tone LLM replica may analyze the queries for the emotional tone. For instance, a student struggling with a complex mathematical problem might express frustration or confusion. The backend tone LLM replica may recognize these cues and may provide feedback to the frontend LLM replica 142 instructing the frontend LLM replica 142 to respond with a simplified explanation and/or breaks down the problem into more manageable steps. In some aspects, the backend tone LLM replica may facilitate breaking down the explanation into simplified steps.

The AI engine 906 may adapt teaching methods responses based on the student summaries. When a student demonstrates quick comprehension as exhibited in the student summaries, the AI engine 906 may adopt a more challenging approach, presenting advanced problems or thought-provoking questions. When a student is having difficulty based on the student summaries, the AI engine 906 may adopt a more patient and reassuring tone, providing detailed explanations, and encouraging the student to ask questions. The AI engine 906 may personalize learning experiences by referencing students' previous interactions and progress from the contextual summaries. The AI engine 906 may track the student's learning journey, identify strengths and weaknesses, and/or tailor future interactions within the revised summaries following or during exchanges. For example, when a student frequently struggles with a particular concept in the summaries, the AI engine 906 may provide additional resources and/or exercises explicitly targeting that area. Students may provide feedback on their learning experience when reviewing the revised summaries to refine the AI engine 906 ensuring that the AI engine 906 remains effective and responsive to the current learning of the students.

The aspects described herein may apply to a chatbot server 140 for business-customer interaction (i.e. a business-customer chatbot server). The AI engine 906 may be trained on customer service interactions, detecting when customer feedback, and/or complaints are not sufficiently addressed. The backend LLM replica 146 may search for patterns indicating dissatisfaction, such as repeated complaints, unresolved issues, and/or negative sentiment expressed in customer feedback. When such instances are identified, the backend LLM replica 146, trained on a vast database of customer service resolutions, may suggests alternative approaches and/or responses to the frontend LLM replica 142. This backend LLM replica 146 may be provided with a database of successful customer service resolutions, business policies, and/or strategies. For example, the backend LLM replica 146 may recommend different wording for a response, suggest additional compensation and/or solutions to the customer's issue, and/or propose changes to company policies that are repeatedly causing dissatisfaction. The backend LLM replica 146 may analyze trends and patterns in customer feedback across exchanges between a plurality of frontend LLM replicas 142 to identify areas where services and/or products may be improved. The AI engine 906 may integrate with existing customer relationship management (CRM) systems to ensure that the tool can analyze and improve customer interactions across various platforms, including email, chat, social media, and/or phone. The AI engine 906 may work in real-time, providing immediate suggestions during live customer interactions and/or as a post-interaction analysis tool, offering insights and improvement suggestions after the interaction. The AI engine 906 may adapt over time and update the summaries with new customer service trends, feedback patterns, and/or resolution strategies. The summaries may be used by the frontend LLM replica 142 to provide a general context for the frontend LLM replica 142. Some aspects may have additional summaries specific to each particular customer.

The aspects described herein may apply to a chatbot server 140 for Interactive Voice Response (IVR) (i.e. an Interactive Voice Response (IVR) chatbot server). The AI engine 906 may be trained on voice interactions in customer service settings. The frontend LLM replica 142 may analyze spoken customer queries and responses from the IVR system. The backend tone LLM replica may detecting instances where the customer's query is not adequately addressed, in which repeated questions may indicate requests to speak to a human agent, and/or signs of frustration in the customer's tone or choice of words. When the backend tone LLM replica detects an insufficient response or an unsatisfactory customer interaction, the backend tone LLM replica may provide feedback to the frontend LLM replica 142. Unlike traditional IVR systems that may follow a fixed script, this AI engine 906 may dynamically generate responses based on the specific nature of the customer's query, ensuring a more personalized and effective resolution. The AI engine 906 may provide responses to complex requests, provide detailed information, and/or perform specific tasks like scheduling appointments and processing payments, which traditional IVR systems might handle inadequately. The AI engine 906 may be provided with summaries of previous exchanges with the customer as the customer may typically enter an identification code into the IVR system, such as a credit card number.

In some aspects, the content-based summary may be based on the chunks described above. The content-based summaries may comprise one or more of an automatically generated conversation title, a bullet point summary of the exchange(s), a highlight of any actions that were decided, a timeline of events, and any files referenced or generated.

The software application 270 may be accessible on the client device 110. For example, the software application 270 may be provided via a web interface that can be accessed using a web browser on the client device 110. Additionally, or alternatively, the software application 270 may be an application, different from a web browser, operating on the client device 110. For example, the software application 270 may be stored in memory of the client device 110 and executed thereon, such as a mobile app.

Although the description is directed to LLMs, other aspects may have LLM replicas as the AI-assistant chatbots, such as one or more rule-based systems, decision trees, support vector machines (SVM), K-nearest neighbors (KNN), Naïve Bayes, Recurrent Neural Networks (RNN), Convolutional Neural Networks (CNN), Transformers, Graph Neural Networks (GNN), autoencoders, and/or other similar AI-based chatbots.

Although chatbot servers 140 have been described herein, one of skill in the art on review of the present application may contemplate other applications for the techniques described herein. The aspects described herein may apply to any other types of chatbot servers 140 in other types of applications.

In the aspects herein, the AI engine 906 is shown having a particular number of the frontend LLM replicas 142 and the backend LLM replicas 146. The frontend LLM replicas 142 may be assisted by one or more backend LLM replicas 146. The chatbot server 140 may host the AI engines 906 capable of training multiple of the frontend LLM replicas 142 and/or multiple of the backend LLM replicas 146 at the same time. For example, multiple AI engines 906 may train multiple of the frontend LLM replicas 142 and/or multiple of the backend LLM replicas 146 to generate chatbot responses. The multiple of the frontend LLM replicas 142 and/or multiple of the backend LLM replicas 146 may be different, for example, different algorithms. As another example, the multiple of the frontend LLM replicas 142 and/or multiple of the backend LLM replicas 146 may be based on the same algorithm but trained using different training data. This results in multiple of the frontend LLM replicas 142 and/or multiple of the backend LLM replicas 146 capable of responding differently to the same query from the entity.

Although the aspects herein describe the frontend LLM replicas 142 and the backend LLM replicas 146 as being the same type, other aspects may have the frontend LLM replica 142 being different from the backend LLM replica 146. In another aspect, the frontend LLM replica 142 may iteratively refine the response until the response meets a quality threshold. In another aspect, the frontend LLM replica 142 may iteratively refine the response by incorporating feedback from one or more backend LLM replicas 146. In other aspects, the frontend LLM replicas 142 may comprise one or more layers of frontend LLM replicas 142 and the backend LLM replicas 146 may comprise one or more layers of backend LLM replicas 146 working together. In a stacked architecture, a plurality of the frontend LLM replica 142 and/or a plurality of the backend LLM replica 146 may be layered on each other. Each layer may be an AI model 908 distinctly trained on different datasets or optimized for different aspects of response generation. For example, one layer might focus on understanding the context and content of the conversation, another on ensuring grammatical correctness and language fluency, while another could be dedicated to aligning the response with specific quality parameters like accuracy or appropriateness. The response generation process in this stacked model may be sequential. A query may be processed by the initial layer, which generates a preliminary response. This response may then be passed to the next layer, which refines or alters the response based on its specialized function. This process continues through each stack layer until the final output is produced. At a stage in this sequential process, one or more layers are tasked with evaluating the quality of the response. This evaluation is based on predefined criteria, such as relevance to the query, coherence, adherence to ethical guidelines, factual accuracy, and user engagement potential. When a response does not meet the set quality threshold at a given layer, the response may be looped back for reprocessing or modification by previous layers. In other aspects, the backend models may provide input to the frontend models.

In the aspects described herein, the chatbot server 140 may execute conversations with entities through a chat window of a software application. This interaction may occur in real-time, where the AI engine 906 and the entity exchange content seamlessly within the chat window interface. In other aspects, the software application may be a mobile application with front-end components on the client device, back-end elements on the chatbot server 140, or a progressive web application accessible via a web browser. When the entity inputs a chat communication, the software application receives the data within the chat window. The chatbot server 140 may leverage an advanced AI engine 906 trained to understand and analyze conversation contexts. The AI engine 906 may use inputs, including the current chat communication, previous conversations, and/or topic data, to assess. In particular, the AI engine 906 may be provided with a contextual summary of previous exchanges.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. The executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace all suitable changes in technology.

1. A computer system comprising:
a processor;
a communications module coupled to the processor; and
a computer-readable memory coupled to the processor, the computer-readable memory storing a plurality of instructions that, when executed, configure the processor to:
generate a summary of an exchange;
receive a query via the communications module;
identify, based on the summary of the exchange, at least a portion of the summary resembling the query; and
augment the query with the portions of the summary or the exchange to the computer-readable memory as input, to generate a response.

2. The computer system according to claim 1, wherein the instructions further configure the processor to: revise the summary based on the response.

3. The computer system according to claim 1, wherein the instructions further configure the processor to: perform chunking on the exchange to provide a plurality of chunks.

4. The computer system according to claim 3, wherein the instructions further configure the processor to: merge the response with a contextually-similar chunk from the plurality of chunks to produce a merged chunk.

5. The computer system according to claim 4, wherein the instructions further configure the processor to: generate an embedding of the merged chunk and store the embedding in a vector database.

6. The computer system according to claim 5, wherein the instructions further configure the processor to: convert the query into a query embedding; and identify at least one embedding from the vector database resembling the query embedding to identify the portion of the summary resembling the query.

7. The computer system according to claim 2, wherein the instructions further configure the processor to: provide the response and the summary of the exchange to an artificial intelligence (AI)-assistant chatbot to revise the summary.

8. The computer system according to claim 1, wherein the instructions further configure the processor to: provide the summary of at least one previous exchange associated with an account to an AI-assistant chatbot prior to receiving the query.

9. The computer system according to claim 2, wherein the instructions further configure the processor to: provide the revised summary via the communications module to a remote device.

10. The computer system according to claim 9, wherein the instructions further configure the processor to: receive a confirmation message from the remote device via the communications module indicating the revised summary is accurate.

11. A computer-implemented method comprising:
generating a summary of an exchange;
receiving a query via a communications module;
identifying, based on the summary of the exchange, at least a portion of the summary resembling the query; and
augmenting the query with the portions of the summary or the exchange to the computer-readable memory as input, together with the query, to answer the query with a response.

12. The computer-implemented method according to claim 11, further comprising: revising the summary based on the response to produce a revised summary.

13. The computer-implemented method according to claim 11, further comprising: performing chunking on the exchange to provide a plurality of chunks.

14. The computer-implemented method according to claim 13, further comprising: merging the response with a contextually-similar chunk from the plurality of chunks to produce a merged chunk.

15. The computer-implemented method according to claim 14, further comprising: generating an embedding of the merged chunk and storing the embedding in a vector database.

16. The computer-implemented method according to claim 15, further comprising: converting the query into a query embedding; and identifying at least one embedding from the vector database resembling the query embedding to identify the portion of the summary resembling the query.

17. The computer-implemented method according to claim 12, further comprising: providing the response and the summary of the exchange to an AI-assistant chatbot to revise the summary.

18. The computer-implemented method according to claim 11, further comprising: providing the summary of at least one previous exchange associated with an account to an AI-assistant chatbot prior to receiving the query.

19. The computer-implemented method according to claim 12, further comprising: providing the revised summary via the communications module to a remote device.

20. The computer-implemented method according to claim 19, further comprising: receiving a confirmation message from the remote device via the communications module indicating the revised summary is accurate.
